(19) United States
(12) Patent Application Publication
(10) Pub. No.: US 2004/0258154 A1
(43) Pub. Date: Dec. 23, 2004

(54) System and method for multi-stage predictive motion estimation

(75) Inventors: Shizhong Liu, San Diego, CA (US); Jin Li, Sammamish, WA (US)

Correspondence Address: Mark A. Watson, Lyon & Harr, Suite 800, 300 Esplanade Drive, Oxnard, CA, 93030, US

(73) Assignee: Microsoft Corporation, Redmond, WA

(21) Appl. No.: 10/600,520

(22) Filed: Jun. 19, 2003

(51) Int. Cl. H04N 7/12

(52) U.S. Cl. 375/240.16; 375/240.24; 375/240.12

(57) ABSTRACT

A “predictive motion estimator” operates by conducting one or more stages of a multi-stage motion vector (MV) search. A first stage involves performing a background detection process for determining possible MVs. In a second stage, candidate MVs are determined in spatial and temporal neighborhoods. Finally, in a third stage, candidate MVs are determined through MV refinement or pattern searching. Reliability of motion estimation results is evaluated at each stage for determining whether to proceed to the next stage. By gradually enlarging the search pool and advancing the search to the next stage only when the reliability of current stage results are unsatisfactory, the predictive motion estimator successfully balances motion vector search complexity and reliability of motion estimation. Further, for ensuring flexibility in adapting to video sequences of various characteristics, the predictive motion estimator derives search parameters for each stage from prior stage motion estimation results, rather than using preset parameters.

### BACKGROUND

1. Technical Field

The invention is related to a system for motion estimation in a video sequence, and in particular, to an efficient multi-stage predictive motion estimation technique that balances motion search complexity and reliability of motion estimation for use in real-time video coding applications.

2. Related Art

In general, motion estimation is an important part of conventional video encoders. In particular, in conventional video coding systems such as, for example, MPEG-1, MPEG-2 and MPEG-4, motion estimation plays a key role in removing temporal redundancy among successive video frames so that high compression gain can be achieved. As a result, accurate and efficient motion estimation can have a significant impact on the bit rate and the output quality of an encoded video sequence. Unfortunately motion estimation accounts for a significant amount of the total encoding time for typical video encoders. The most straightforward motion estimation scheme is known as the full search (FS) algorithm. This FS algorithm exhaustively searches all possible motion vector (MV) positions to find a minimum of the sum of absolute difference (SAD) for identifying the proper motion vectors. Unfortunately, even though FS block-matching achieves an optimal motion estimation solution, its high computational complexity renders it impractical in most real-time video coding applications.

Various fast search algorithms have been proposed to accelerate the motion estimation procedure by either reducing the number of MV search positions through a certain search pattern or reducing the computational cost of evaluating each position. However, conventional techniques have not yet provided enough of a performance increase for reliable real-time encoding operations.

One class of conventional fast “block-matching” or “block motion estimation” algorithms (BMAs) involving BMAs utilize a predefined search pattern for determining motion vectors. It has been observed that the use of different shapes or sizes of the BMA search pattern has a very important impact on search speed and distortion performance. Typical pattern-based motion estimation searches include searches such as, for example, a square-shaped search pattern or a diamond-shaped search pattern.

The three-step search (TSS) algorithm is a popular fast BMA with predefined search patterns for motion estimation in low bit-rate video compression applications. At each step, TSS checks nine MVs with a uniform distance from the central vector. The optimal MV becomes the new central vector for the next step, with distance between the MVs reduces by a factor of 2 with each successive search step. Since TSS uses a uniformly allocated checking point pattern, it is inefficient for the estimation of small MVs. A related three-step search algorithm termed NTSS” for “new three-step search” employs a center-biased checking point pattern in the first step, which is derived by making the search adaptive to the motion vector distribution, and a halfway-stop technique to reduce the computation cost. Simulation results show that, as compared to TSS, NTSS is much more robust, produces smaller motion compensation errors, and has a very compatible computational complexity.

Another conventional fixed patterned fast BMA algorithm involves a motion estimation technique referred to as a “diamond search (DS)”, or an improved version termed an “advanced diamond zonal search” (ADZS). The DS and ADSZ use a diamond search pattern instead of the nine MVs in TS or NTSS. It is shown that ADSZ is significantly faster than the conventional DS and NTSS (in terms of number of checking points and total encoding time) while providing similar quality (in terms of PSNR) of the output sequence. However, as with other such pattern-based searches, the DS and ADZS scheme is still not as reliable as the full search.

Another conventional pattern-based search is based on a hexagon-based search pattern. The hexagon-based search (HEXBS) pattern has been demonstrated to provide a significant performance gain over the conventional diamond-based search. In fact, under certain conditions, the HEXBS has been shown to provide an 80% improvement over the performance of the conventional diamond-based search by providing the capability to find the same motion vector with fewer search points than the conventional DS algorithm.

Another conventional scheme provides a lightweight genetic search algorithm (LGSA). This scheme selects the search pattern based on the genetic algorithms. It can be seen from the simulation results that the performance of LGSA is better than the TSS.

All of the pattern based search schemes mentioned above fail to provide significant performance increases, and may also miss the optimal MVs. In fact, any pattern based search schemes divide the search task into several steps, and at each step, evaluate a number of MVs related to the optimal MV found at the last step. The number of MVs evaluated at the first step becomes a lower-bound on the search complexity. Moreover, pattern searches easily fall into local minimum if the global minimum MV does not centered around the best MV at each step. Thus all pattern based searches are not reliable as the aforementioned FS technique.

Finally, another fast motion estimation scheme termed a “predictive algorithm” (PA) has been proposed for exploiting spatio-temporal correlation existing in the motion fields of video sequences for providing efficient real-time motion estimation algorithm for video coding. PA provides a reduction of computational load with good encoding efficiency by exploiting past history of the motion field to predict the current motion field. A successive refinement phase gives the final motion field. This approach leads to a reduction in the number of motion vectors that have to be tested, thereby resulting in an algorithm of low computational complexity which is both constant and independent of any search window area size. However, because the search is restricted to a relatively small set of MVs, when the current block does not undergo similar motion with the set of MVs, it may result in non-optimal MVs with large prediction errors.

Clearly, any further reduction in computational complexity and overhead, with a corresponding increase in overall reliability is beneficial, especially in a real-time video encoding system. Consequently, what is needed is a computationally efficient system and method for estimating motion that improves on existing techniques by simultaneously reducing computational complexity, reducing maximum bit rate, and improving output quality.

### SUMMARY

A “multi-stage predictive motion estimator,” as described herein, operates by conducting a multi-stage block-based motion vector (MV) search for computing motion vectors from an image sequence. The multi-stage predictive motion estimator is efficient, provides a reduction in motion estimation complexity, and improves output quality relative to conventional motion estimation schemes. In fact, in comparison to conventional state-of-the-art motion estimation techniques, the multi-stage predictive motion estimator described herein has been observed to improve motion compensation gain by approximately 0.8 dB for volatile motion sequences with about the same computational complexity as the conventional techniques. Consequently, the predictive motion estimator is well suited for real-time video coding applications.

The multi-stage predictive motion estimator successfully balances MV search complexity with reliability of motion estimation. As noted above, the multi-stage predictive motion estimator operates by conducting a multi-stage block-based MV search, with each successive stage using increasingly complex, and increasingly accurate, search methods along with a larger search pool. In particular, the first stage involves performing a conventional background detection process for determining possible MVs. Next, if necessary, candidate MVs are determined in spatial and temporal neighborhoods. Finally, if necessary, candidate MVs are determined through MV refinement or a pattern search, such as, for example, a square, spiral, diamond, hexagonal, 2 D logarithmic search, or any other conventional pattern search. Further, for ensuring flexibility in adapting to video sequences of various characteristics, the multi-stage predictive motion estimator derives stop criterion for each stage from prior motion estimation results, rather than using preset parameters.

As with other motion estimation algorithms, the multi-stage predictive motion estimator evaluates a number of MV. In general, the quality of each MV is determined for each stage either by maximizing the cross correlation function for blocks of pixels between the current and reference image frames or minimizing an error criterion for the pixel blocks. These techniques are well known to those skilled in the art. For example, conventional error criterion typically used in image compression, such as MPEG-4 video coding, include sum of absolute differences (SAD), mean square error (MSE), sum of squared error (SSE), mean absolute error (MAE), etc. Each of these techniques for minimizing error of computed MVs are well known to those skilled in the art, and will not be described in detail herein.

Regardless of which of these methods is used, cross correlation, SAD, MSE, etc., the point is to identify the MVs that best explain the motion from one image frame to the next, so as to allow for minimum bits to represent a residual error while maximizing the quality of reconstructed image frames. Further, these computations, cross correlation, SAD, MSE, etc., also serve to provide an estimate of the reliability of the computed MVs, with the reliability of the estimates increasing as the error decreases. Note that for purposes of explanation and ease of understanding, the following discussion assumes that a conventional SAD process for minimizing error of computed MVs is used. However, it should be clear that any conventional method for computing or estimating the reliability of a computed set of MVs for each stage may be used by the predictive motion estimator described herein.

Once MVs have been determined for any stage, the computed error is used as a reliability indicator to determine whether it is necessary to proceed to the next stage. This reliability indicator at each stage is compared to a predetermined stage-dependent reliability threshold. These stage dependent reliability thresholds are used to specify a minimum acceptable reliability at each motion estimation stage. If the computed error for a particular stage is less than the reliability threshold for that stage, then the computed motion estimates are assumed to be sufficiently reliable, and the motion estimates are output as the motion field for that image frame without proceeding to the next stage. In this fashion, a desired reliability is achieved by using the lowest complexity, lowest cost search method and gradually enlarging the search pool and advancing the search to the next stage only when the current stage result is deemed unsatisfactory.

In addition to the just described benefits, other advantages of the multi-stage motion estimation techniques described herein will become apparent from the detailed description which follows hereinafter when taken in conjunction with the accompanying drawing figures.

### DESCRIPTION OF THE DRAWINGS

The specific features, aspects, and advantages of the present invention will become better understood with regard to the following description, appended claims, and accompanying drawings where:

FIG. 1 is a general system diagram depicting a general-purpose computing device constituting an exemplary system for using a multiperspective plane sweep to combine two or more images into a seamless mosaic.

FIG. 2 illustrates an exemplary architectural diagram showing exemplary program modules for estimating motion vectors for use in encoding image sequences.

FIG. 3 illustrates an exemplary flow diagram for a working embodiment of a system for estimating motion vectors for use in encoding image sequences.

FIG. 4A illustrates selection of temporal neighbors in an exemplary spatio-temporal motion vector search.

FIG. 4B illustrates selection of spatial neighbors in an exemplary spatio-temporal motion vector search.

FIG. 5 illustrates an exemplary two-stage hexagonal motion vector search.

FIG. 6 illustrates an exemplary system flow diagram for estimating motion vectors for use in encoding image sequences.

### DETAILED DESCRIPTION OF THE PREFERRED EMBODIMENTS

In the following description of the preferred embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

1.0 Exemplary Operating Environment

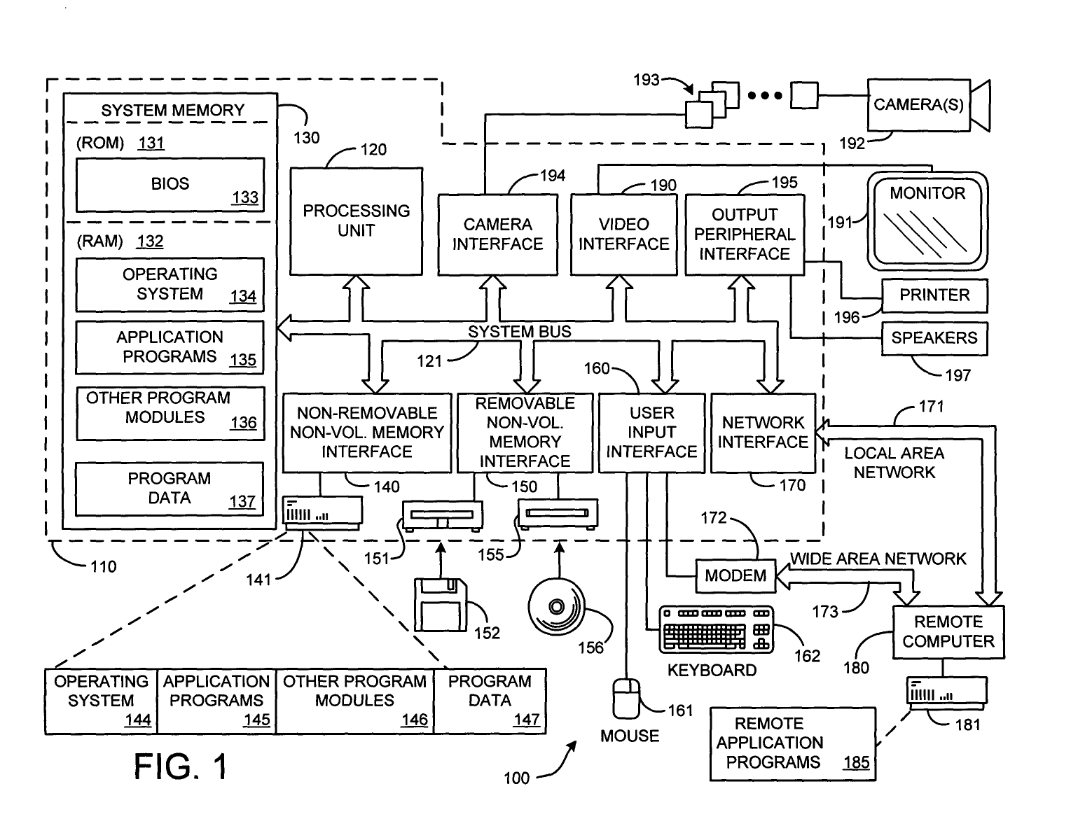

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 1, an exemplary system for implementing the invention includes a general-purpose computing device in the form of a computer 110.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media.

The aforementioned term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

Further, the computer 110 may also include, as an input device, a camera 192 (such as a digital/electronic still or video camera, or film/photographic scanner) capable of capturing a sequence of images 193. Further, while just one camera 192 is depicted, multiple cameras could be included as input devices to the computer 110. The use of multiple cameras provides the capability to capture multiple views of an image simultaneously or sequentially, to capture three-dimensional or depth images, or to capture panoramic images of a scene. The images 193 from the one or more cameras 192 are input into the computer 110 via an appropriate camera interface 194. This interface is connected to the system bus 121, thereby allowing the images 193 to be routed to and stored in the RAM 132, or any of the other aforementioned data storage devices associated with the computer 110. However, it is noted that image data can be input into the computer 110 from any of the aforementioned computer-readable media as well, without requiring the use of a camera 192.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining part of this description will be devoted to a discussion of the program modules and processes embodying a “predictive motion estimator.”

2.0 Introduction

In general, the multi-stage predictive motion estimator described herein provides an efficient multi-stage predictive motion estimation process for determining motion vectors for frames in an image sequence. The motion vector search is completed in one or more of three stages, with each subsequent stage including a more detailed search with a larger pool of candidate MVs. Advancement to the next stage occurs only when the search results of the current stage is deemed to be unsatisfactory.

2.1 System Overview

As is well known to those skilled in art, motion estimation involves estimating or predicting camera motion or the movements of objects in image sequences. Typically such motion estimates involves computing motion vectors for blocks of pixels, such as 16×16 or 8×8 pixel blocks. Note that the computational speed of the predictive motion estimator increases as the block size increases, while the computational speed decreases as the block size decreases. This is an obvious result of the fact that as the block size increases, there are fewer blocks to process for any given image frame. Further, as with conventional block-based MV schemes, motion compensation gain increases as the block size decreases. Regardless of the block size used, the motion estimates are then typically used for encoding image frames in the image sequence. In general, the basic idea is that in most cases, consecutive video frames are similar except for relatively small changes resulting from the movement of objects between image frames, or from the movement of the camera between image frames. Given the motion estimates, or motion vectors (MVs), image frames are then encoded.

For example, in the trivial case of zero motion between frames (and no other differences caused by lighting changes, noise, etc.), it is easy for an encoder to efficiently predict the current frame as a duplicate of the prediction frame. When this is done, the only information necessary to transmit to the decoder becomes the syntactic overhead necessary to reconstruct the picture from the original reference frame. Of course, in the case where there is motion in the images, encoding becomes more complex. However, MV-based encoding is well known to those skilled in the art, and is fully documented by a large number of conventional encoding standards, such as, for example, MPEG-1, MPEG-2, MPEG-4, etc. Therefore, as these MV-based encoding techniques are well known, they will only be generally described herein.

In general, temporal and spatial coherence between image frames in an image sequences allows frames to be estimated from past and future frames through predicted or estimated motions, thereby allowing for large image compression gains. In most conventional motion estimation or prediction schemes, block matching algorithms (BMA) are used to determine the displacement of a particular pixel f(x,y) in an image frame at a time t, with the displacement of that pixel being considered the block motion with f(x,y) centered in the pixel block at time t. Forward block motion, or the motion of the current image frame, is found by searching the frame at t-1 for the best matching block of the same size.

As described in further detail below, matching is performed by either maximizing a cross correlation function between blocks or by minimizing a conventional error criterion. Such error criterion include, for example, the sum of absolute differences (SAD), mean square error (MSE), sum of squared error (SSE), mean absolute error (MAE), etc.

A “multi-stage predictive motion estimator,” as described herein, operates by conducting a block-based multi-stage motion vector (MV) search that is efficient, provides a reduction in motion search complexity and improves output quality relative to conventional motion estimation schemes. The process begins by first performing a background detection process as a first stage for determining possible motion vectors. Next, if the results of the background detection do not provide good results, candidate MVs are determined by a second stage in spatial and temporal neighborhoods. Finally, if the results of the spatio-temporal search are not acceptable, then candidate motion vectors are determined in a third stage through MV refinement or a pattern search, such as a square, diamond, or hexagonal search.

The predictive motion estimator evaluates the reliability of the motion estimation results at each stage, and then decides whether it is necessary to proceed to the next stage. By gradually enlarging the search pool and advancing the search to the next stage only when the current stage result is deemed unsatisfactory, the predictive motion estimator successfully balances motion vector search complexity and the reliability of motion estimation. Further, for ensuring flexibility in adapting to video sequences of various characteristics, the predictive motion estimator derives stop criterion for each stage from prior motion estimation results, rather than using preset parameters.

2.2 System Architecture

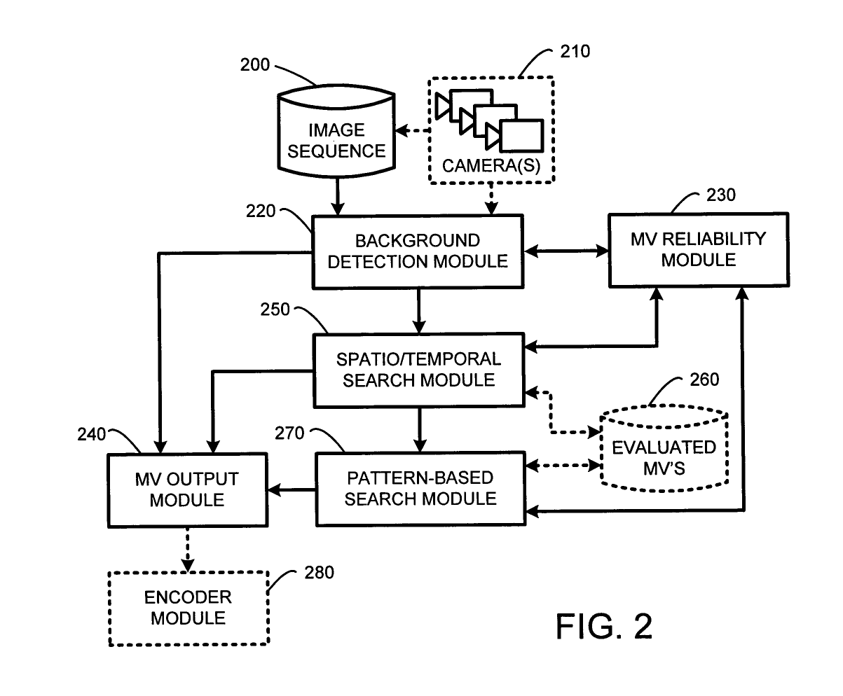

The general system diagram of FIG. 2 illustrates the processes summarized above. In particular, the system diagram of FIG. 2 illustrates the interrelationships between program modules for implementing the predictive motion estimator. It should be noted that the boxes and interconnections between boxes that are represented by broken or dashed lines in FIG. 2 represent alternate embodiments of the motion vector estimation methods described herein, and that any or all of these alternate embodiments, as described below, may be used in combination with other alternate embodiments that are described throughout this document.

As illustrated by FIG. 2, a system and method for predicting motion vectors for each image frame in an image sequence begins by inputting an image or video sequence 200 from either one or more files or databases, or from one or more video cameras 210 into a background detection module 220. The background detection module 220 uses conventional block-based background subtraction techniques to determine, for each block of pixels in the current image frame, whether that block is a background block, or whether that block exhibits motion. Any pixel blocks that are determined to be approximately stationary, relative to the previous image frame, are considered to be a part of the background and are assigned a zero motion vector. However, before definitively identifying a particular block as having a zero MV, an MV reliability module 230 first uses conventional error estimation techniques, such as SAD, MSE, etc, as described above, to evaluate the predicted error for each MV candidate. If the predicted error is below a first error threshold for any given block, then the MV candidate for that block is assigned a zero MV. Next, those blocks of the current image frame that are assigned a zero MV are provided to an MV output module 240 for outputting the MVs.

If any blocks in the current image frame are not assigned a zero MV by the background detection module 220, either because those blocks exhibited motion, or because the error criterion for those blocks exceeded the aforementioned first error threshold, then those blocks are passed to a second stage of the predictive motion estimator.

The second stage of the predictive motion estimator is embodied in a spatio/temporal search module 250. In alternate embodiments, the spatio/temporal search module 250 uses any of a spatial neighbor search for identifying candidate MVs based on neighboring pixel blocks, a temporal neighbor search for identifying candidate MVs based on pixel blocks in a prior, or “prediction”, image frame, or a combined spatial and temporal search for identifying candidate MVs using both spatial and temporal neighbors of the current pixel block. Further, for ensuring flexibility in adapting to video sequences of various characteristics, the predictive motion estimator derives stop criterion for the second stage from prior motion estimation results, rather than using preset parameters.

Further, as with the first stage, the MV reliability module 230 uses conventional error estimation techniques to evaluate the predicted error for each MV candidate. If the predicted error is below a second error threshold for any given block, then the computed MV is provided to the MV output module 240.

In addition, in a related embodiment, computed MV error values are stored to an array or database of evaluated MVs 260. In operation, this database 260 is first checked to see if the motion vector for a particular pixel block has already been evaluated. If it has, then the value is simply read back rather than wasting computer time to recompute predicted error values. This particular embodiment serves to significantly increase overall system efficiency, especially since particular image blocks will be neighboring blocks to several other blocks, and could potentially be subject to having the error evaluation recomputed several times if the value were not stored. Further, these same values are also useful for reducing the number of potential error evaluations in the third stage should it be necessary to evaluate any pixel blocks in that third stage.

As with the first stage, if the predicted error associated with the MV computed for any pixel blocks in the second stage exceeds the second error threshold, then those pixel blocks are passed to a third stage for evaluation. Further, for ensuring flexibility in adapting to video sequences of various characteristics, the predictive motion estimator derives stop criterion for the third stage from prior motion estimation results, rather than using preset parameters

The third stage uses a pattern-based search module 270 to provide a conventional block-based pattern search. Such block-based pattern searches include, for example, a square, spiral, diamond, hexagonal, 2 D logarithmic search, or any other conventional pattern search including a full search. Each of these search techniques are well known to those skilled in the art, and so will only be generally described herein. Regardless of which pattern-based search is used in this third stage, the MV for each remaining block exhibiting the smallest predicted error is chosen as the best MV for each particular block, and provided to the MV output module 240. At this point, the next image frame is then processed in the same manner as described above until all image frames have been processed.

Further, as with the second stage, in one embodiment the computed MV error values are again stored to the array or database of evaluated MVs 260. In operation, this database is first checked to see if the motion vector for a particular pixel block has already been evaluated, in any of the stages, including the current stage. If it has, then the value is simply read back rather than wasting computer time to recompute predicted error values.

Once all of the MVs for the pixel blocks for the current image frame have been computed in one of the three stages and provided to the MV output module 240, the MVs for that image frame are output for further use or processing as desired. For example, these MVs will typically be sent to an encoder module 280 which uses any conventional MV-based encoding techniques to encode the current image frame. Such MV-based encoding techniques include MPEG-1, MPEG-2 and MPEG-4 coding techniques, among others.

3.0 Operation Overview

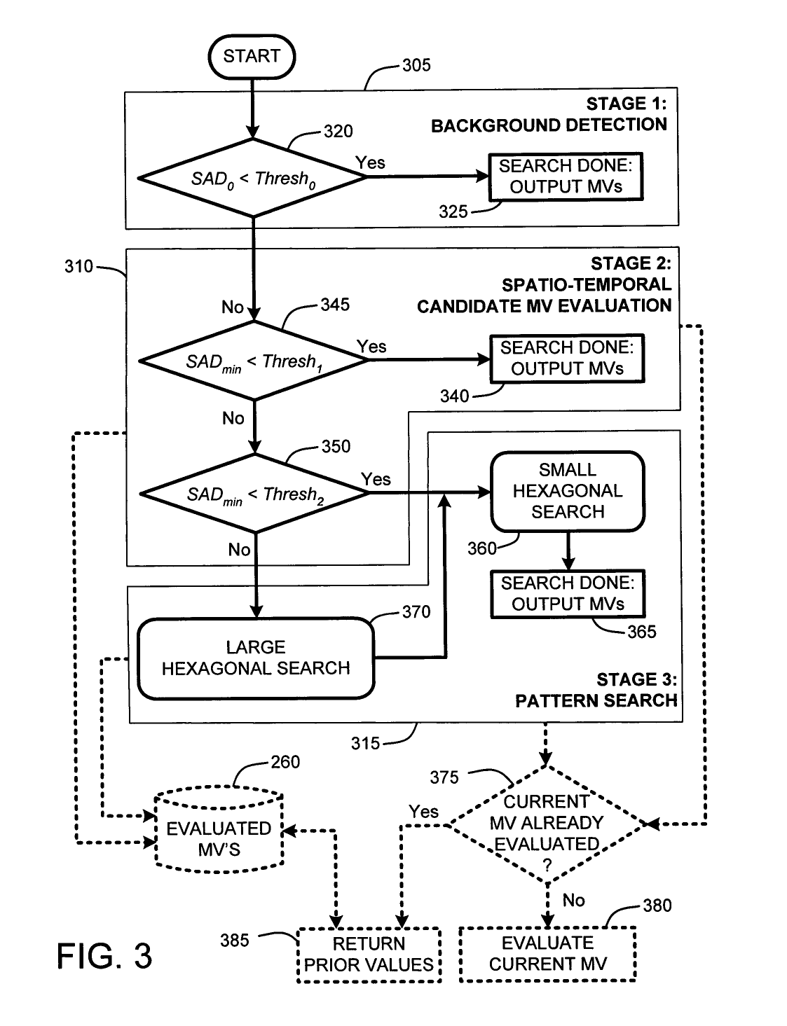

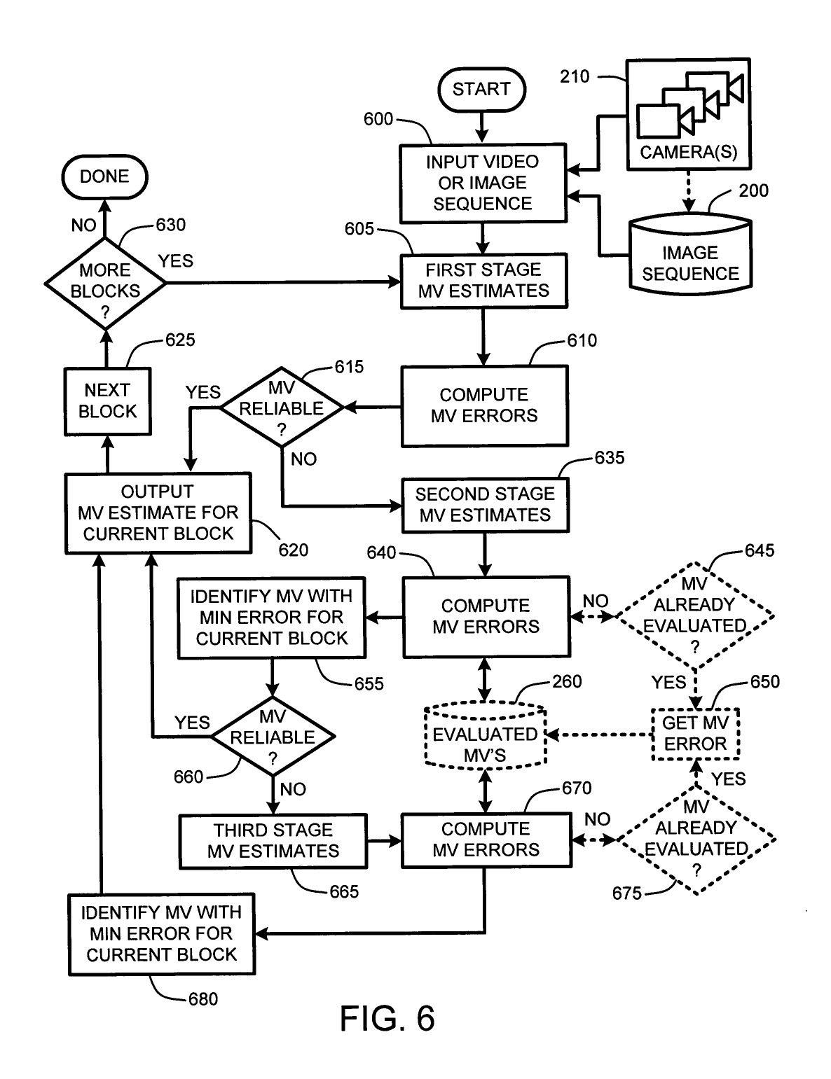

The above-described program modules are employed in a predictive motion estimator for automatically computing MVs for describing motions in image frames for use in encoding those image frames relative to prior image frames. This process is depicted in the flow diagram of FIG. 6 following a detailed operational discussion of exemplary methods for implementing the aforementioned programs modules along with a discussion of a tested embodiment of the predictive motion estimator as illustrated by FIG. 3.

3.1 Operational Elements

The following sections describe in detail the operational elements for implementing the predictive motion estimator using the processes summarized above in view of FIG. 3 through FIG. 5. In general, the motion estimation techniques described herein address the problem of computational complexity and reliability in motion estimation by using a multi-stage motion estimation process that estimates motions between successive image frames.

The predictive motion estimator successfully balances motion vector search complexity and the reliability of motion estimation. As noted above, the predictive motion estimator operates by conducting a multi-stage motion vector (MV) search, with each successive stage using increasingly complex search methods along with a larger search pool.

In particular, with respect to FIG. 3, the first stage 305 involves performing a conventional background detection process for determining possible motion vectors. Next, if necessary, candidate MVs are determined in spatial and temporal neighborhoods in a second stage 310. Finally, if necessary, candidate motion vectors are determined in a third stage 315 through MV refinement or a pattern search, such as, for example, a square, diamond, hexagonal, or 2 D logarithmic search, or any other conventional pattern search. Further, as described below, for ensuring flexibility in adapting to video sequences of various characteristics, the predictive motion estimator derives stop criterion for each stage from prior motion estimation results, rather than using preset parameters.

At each stage, 305, 310 and 315, the multi-stage predictive motion estimator evaluates a number of MVs. In general, the optimal MV is determined for each stage by either maximizing the cross correlation function for blocks of pixels in adjacent image frames or minimizing an error criterion for the pixel blocks. These techniques are well known to those skilled in the art. For example, conventional error criterion used in image compression include sum of absolute differences (SAD), mean square error (MSE), sum of squared error (SSE), mean absolute error (MAE), etc. Each of these techniques for minimizing error of computed motion vectors are well known to those skilled in the art, and will not be described in detail herein.

Regardless of which of these methods is used, cross correlation, SAD, MSE, etc., the point is to identify the motion vectors that best explain the motion from one image frame to the next. Further, these computations, cross correlation, SAD, MSE, etc., also serve to provide an estimate of the reliability of the computed motion vectors, with the reliability of the estimates increasing as the error decreases. Note that for purposes of explanation and ease of understanding, the following discussion assumes that a conventional SAD process for minimizing error of computed motion vectors is used. However, it should be clear that any conventional method for computing or estimating a reliability of a computed set of motion vectors for each stage may be used by the predictive motion estimator described herein.

Once motion vectors have been determined for any stage, the computed error is used as a reliability indicator to determine whether it is necessary to proceed to the next stage. This reliability indicator at each stage is compared to a predetermined stage-dependent reliability threshold. These stage dependent reliability thresholds are used to specify a minimum acceptable reliability at each motion estimation stage. If the computed error for a particular stage is less than the reliability threshold for that stage, then the computed motion estimates are assumed to be sufficiently reliable, and the motion estimates are output as the motion field for that image frame without proceeding to the next stage. In this fashion, a desired reliability is achieved by first using the lowest complexity, lowest cost, search method, and then gradually increasing search complexity and enlarging the search pool. Again, as noted above, advancement from one stage to the next occurs only when the current stage results are deemed unsatisfactory.

3.1.1 Stage One: Background Detection

In typical image sequences, a significant portion of each image frame usually represents “background.” Such image background is best described as those areas of the image frame that do not move if the camera is stationary. Since the background region is so common, the first operational stage 305 of the multi-stage predictive motion estimator involves detecting those pixel blocks in the current image frame that represent background. Any conventional background detection method may be used here, such as, for example, conventional background subtraction techniques wherein a first image is subtracted from a second image to identify unchanging, or background, regions within the images. Once identified, those blocks of the each image frame that are considered to represent background are assigned an MV having a value of zero, i.e., a “zero MV.”

In particular, in identifying such background blocks, the predictive motion estimator first evaluates the SAD value of the zero MV for each block and records that value as SAD₀. If SAD₀ is smaller 320 than a predetermined or user adjustable threshold, thresh₀, for a given block, then the predictive motion estimator terminates with respect to that block and outputs 325 a zero MV for that block. Note that in a working embodiment, thresh₀ was set equal to the block size. Any blocks that are not assigned a zero MV at this first stage are passed to the second stage for determining the MV for each remaining block.

3.1.2 Stage Two: Spatio-Temporal Candidate MV Evaluation

In the second stage 310, spatio-temporal candidate MV evaluation is used to determine MVs for the remaining blocks of the current image frame. Note that in alternate embodiments of this second stage, the evaluations consist of any one of spatial, temporal, or spatio-temporal evaluations.

As is known to those skilled in the art, the motion field for an image sequence typically varies slowly and smoothly in both the spatial and temporal domain. Consequently, a strong correlation typically exists between the MV of the current block and those of its spatial and temporal neighbors. Therefore, it is probable that the current block will undergo the same motion as its spatial and temporal neighbors. The second stage 310 of the predictive motion estimator takes full advantage of this correlation by evaluating the MVs of the spatial, temporal, or spatio-temporal neighbors of the current block.

The following paragraphs describe the use of a spatio-temporal search for evaluating the MVs. However, as should be appreciated by those skilled in the art, the use of either a spatial or temporal neighbor search rather than the combined spatio-temporal search is a straightforward subset of the combined spatio-temporal search. Consequently, although alternate embodiments of the predictive motion estimator include a spatial search, a temporal search, or a combined spatio-temporal search, only the combined search will be described in detail below.

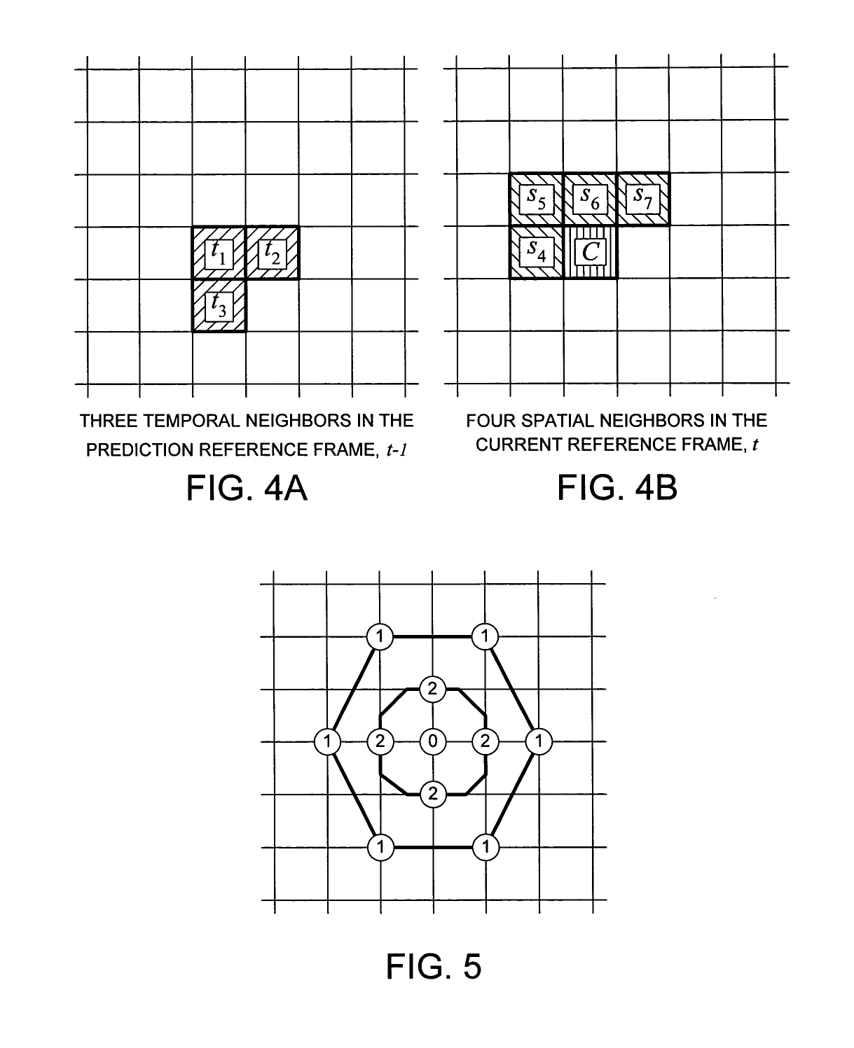

In particular, in performing a spatio-temporal search of the second stage 310, a working embodiment of the predictive motion estimator selects seven prediction candidates (see FIGS. 4A and 4B), where t₁- t₃ are three temporal neighbors, and s₄-s₇ are four spatial neighbors, respectively of the current block C. Note that either more or less temporal or spatial neighbors can be chosen, and that the use of three temporal neighbors and four spatial neighbors was chosen simply as a matter of convenience. As illustrated by FIGS. 4A and 4B, the block t₁ is at the same pixel location of the current block C shown in FIG. 4B, but at the reference frame t-1. Note that this reference frame at t-1 is what is being matched with the current frame to find the MV; it is typically the image frame immediately preceding the current image frame, although it can be a later frame if bi-directional motion compensation is used. Further, if any of the spatio-temporal neighbor blocks is outside of the frame boundary, it is assumed that its predictive MV is zero (0,0), whose SAD value has already been evaluated in the background detection stage.

In particular, let MV₀=(0,0) be the zero MV, and MVᵢ be the already calculated MV of blocks tᵢ(i=1-3) or sᵢ(i=4-7). Each block MVᵢ is termed a “candidate MV” of the current block C, because as a result of the aforementioned spatial and temporal correlation, it is probable that the current block C moves in the same direction and magnitude as one of those MVs (tᵢ or s₁). Therefore, for each candidate MVᵢ, the SAD value of the current block C is evaluated and recorded as SADᵢ. It is possible that one of the candidate MVs is zero MV, or the same as the other candidate MVs.

Further, as noted above, in one embodiment, in order to avoid evaluating the SAD value of the same MV multiple times, a two dimensional SAD array 260 c[x,y] is used to record the SAD of motion vector MV₀=(x,y) for the current block C. This array 260 is then checked prior to evaluating the MVs for a particular block. If the value is already entered in the array 260, it is simply read back rather than being reevaluated, as evaluating a MV by calculating its SAD is a much expensive process than reading back a value from a table.

For example, assuming that the MV search range is [−R,R]×[−R,R], then there is (2R+1)² entries in the array c 260. Once the predictive motion estimator passes the background detection stage, then the array c 260 is initialized by setting c[0,0]=SAD₀ and −1 for the rest of the entries. Each time a MV is evaluated, the array c 260 is first checked to determine whether the corresponding MV has already been evaluated, i.e., the entry c[MV] is non-negative. Every time, the SAD of a new MV value is calculated, that value is entered into the corresponding entry in the array 260. As each candidate MV is evaluated, a determination is first made 375 as to whether it has already been evaluated. If it has not been evaluated, then the evaluation is conducted as normal 380. Alternately, if the MV has already been evaluated, then the earlier computed value is simple returned 385 from the array 260 of previously evaluated MVs. Consequently, this use of the SAD array c 260 ensures that no MV is needlessly evaluated more than once.

Clearly, as is well known to those skilled in the art, the best predictive candidate MV is the one exhibiting the smallest SAD value which is determined as illustrated by Equation 1:

SADₘᵢₙ=min (SAD₁,SAD₂, . . . ,SAD₇) Equation 1

At this point, an evaluation of the reliability the candidate MV having the smallest SAD value is made to determine whether it is acceptable, or whether a next evaluation stage should be used to further refine the MV. The multi-stage predictive motion estimator accomplishes this evaluation by utilizing the SAD values of neighboring blocks as a stop criterion to evaluate the quality of each candidate MV, thereby allowing a determination of whether it is necessary to proceed to the next stage. As described above, any conventional block-based pattern search may be used for the third stage. In this case, a variable representing the result of neighbor block motion estimation, C_SADᵢ, is defined to be the SAD value of the optimal MV of the neighbor blocks, tᵢ(i=1-3) or sᵢ(i=4-7), that have already been computed. Next, an error threshold, thresh₁, is automatically derived from these SAD values, as illustrated by Equation 2:

thresh₁=min(C_SAD₁,C_SAD₂, . . . ,C_SAD₇) Equation 2

If the minimum SAD 345 for the current block is smaller than thresh₁, then the quality of the candidate MV is better than that of any of the spatial or temporal neighbors. Therefore, the multi-stage predictive motion estimator considers the candidate MV as highly reliable, and directly selects the candidate MV as being the best MV for the current block C and outputs 340 that value without proceeding to the third stage. Alternately, if the minimum SAD for the current block is larger than thresh₁ 345, then the MV search proceeds to the third stage.

In a related embodiment, as illustrated by FIG. 3, the multi-stage predictive motion estimator uses a two-level hexagonal third stage 315 that is dependent upon both the minimum and maximum computed SAD values of the spatial and temporal neighbors of the current block along with the minimum SAD value for the candidate MV for that block. In particular, in a tested embodiment of the predictive motion estimator, a variable representing the neighbors of the candidate MVs, C_SADᵢ, is defined to be the SAD value of the blocks, tᵢ(i=1-3) or sᵢ(i=4-7), that have already been computed. Given these SAD values, two separate thresholds are automatically derived as illustrated by Equation 2 (see above) and Equation 3 as illustrated below:

thresh₂=max(C_SAD₁,C_SAD₂, . . . ,C_SAD₇) Equation 3

As illustrated by FIG. 3, if the minimum SAD is smaller than thresh₁ 345 then the quality of the candidate MV is better than that of any of the spatial or temporal neighbors. Therefore, the multi-stage predictive motion estimator selects the candidate MV as being the best MV for the current block C and outputs 340 that value without proceeding to the third stage 315. Alternately, if the minimum SAD is larger than thresh₁ 345, but is smaller than thresh₂ 350, the quality of the candidate MV is deemed to be “marginally satisfactory.” Basically, in this case, the reliability of the candidate MV is considered to be better than some of its neighbors, but worse than certain others. In this case, the third stage 315 described in Section 3.1.3 is invoked; with a limited hexagonal search 360 being conducted around the best MV position (the MV having the minimum SAD) to further refine the motion estimation result, rather than conducting a full hexagonal search 370.

If the minimum SAD is larger than thresh₂ 350, then the current motion estimation result is deemed to be unsatisfactory. In such a case, it is likely that the block C belongs to a different object than its neighbors. As a result, it is likely that block C moves independently of those neighbors. Therefore, there will be little or no temporal or spatial coherence between the current block C and its temporal or spatial neighbors. Consequently, in this case, rather than just refining the MV estimate through a limited hexagonal search 360 of the nearest spatial neighbors, the full hexagonal search 370 described in Section 3.1.3 is employed to find the optimal MV in the entire search range [−R,R]×[−R,R]; Then, a limited hexagonal search 360 is conducted around the optimal MV position (the MV having the minimum SAD) to further refine the motion estimation result.

Further, because both thresh₁ and thresh₂ are derived from the SAD values of already performed motion estimation operations, the predictive motion estimator is not dependent upon preset parameters. Consequently, the predictive motion estimator adapts well to the local characteristics of video sequence without need for user intervention or adjustment of the thresholds.

3.1.3 Stage Three: Motion Vector Refinement—Pattern Searching

As noted above, any conventional pattern search may be utilized for the third stage 315, including, for example, a square, spiral, diamond, hexagonal, or 2 D logarithmic search, etc. However, for purposes of explanation, the following discussion assumes that the aforementioned two-level hexagonal search is used for computing MVs in the third stage 315. However, it should be clear that any conventional pattern search for computing motion vectors between image frames may be used by the predictive motion estimator described herein.

In view of the preceding discussion, it is clear that stage three 315 is only reached where the results of the MV search for the first and second stage, 305 and 310, respectively, are deemed to be unsatisfactory. In other words, if the best predictive candidate MV is unsatisfactory because the minimum error exceeds prior stage error thresholds, then the multi-stage predictive motion estimator performs the third stage 315 MV refinement. The two-level hexagonal search pattern of the third stage 315 is illustrated in FIG. 5.

In particular, as described above, if the candidate MV for the current block, as estimated in the second stage is marginally satisfactory, i.e., its SAD value is greater then thresh₁ and smaller than thresh₂, then a limited hexagonal search 360 consisting of searching the four nearest neighbor MV points (see pattern 2 in FIG. 5) around the best predictive MV (point 0 in FIG. 5) from stage two 310, and refines the motion estimation result by simply identifying the MV having the smallest SAD value between the candidate MV and its neighbors, then outputs 365 that value. On the other hand, if the candidate MV for the current block, as estimated in the second stage is deemed to be unsatisfactory, i.e., its SAD value is greater then thresh₂, then a full conventional hexagonal search 370 is initiated to locate the optimal MV in the full search range (for example, see pattern 1 in FIG. 5 as the search pattern for the first step.) and a limited hexagonal search 360 is conducted around the optimal MV position to further refine the motion estimation result.

Further, during both the limited hexagonal search 360 and the full hexagonal search 370, the aforementioned SAD array c[x,y] 260 described in 3.1.2 is again used to avoid evaluating the same MV more than one time. Again, this process involves a determination 375 for each MV as to whether it has already been evaluated. If it has not been evaluated, then the evaluation is conducted as normal 380. Alternately, if the MV has already been evaluated, then the earlier computed value is simple returned 385 from the array 260 of previously evaluated MVs. Consequently, this use of the SAD array c 260 ensures that no MV is needlessly evaluated more than once.

3.2 System Operation

The program modules described in Section 2.2 with reference to FIG. 2, and in view of the detailed description provided in Section 3.1, are employed for automatically conducting a block-based multi-stage MV search for image frames in an image sequence. This process is depicted in the flow diagram of FIG. 6. It should be noted that the boxes and interconnections between boxes that are represented by broken or dashed lines in FIG. 6 represent alternate embodiments of the present invention, and that any or all of these alternate embodiments, as described below, may be used in combination.

Referring now to FIG. 6 in combination with FIG. 2, the process can be generally described block-based multi-stage MV search process. In particular, as illustrated by FIG. 6, a system and method for automatically conducting a block-based multi-stage MV search begins by inputting 600 a video or image sequence either from one or more cameras 210, or from a file or database 200 into a first stage 605. The first stage 605 uses background subtraction techniques to identify background blocks potentially having a zero MV in the current image frame. After identifying those blocks potentially having a zero MV in the current image frame, MV errors are computed 610 for each MV using SAD, or some other error estimation technique, as described above.

Given the error estimate for each block potentially having a zero MV, the reliability of those MVs is evaluated 615. If the MV for a given block is deemed to be reliable 615, then the MV for that block is output 620. This process continues for each potentially zero MV block in the current image frame 625 until there are no more blocks to process 630.

If the MV for a given block is deemed to be unreliable 615, or the block does not have a zero MV, then those blocks are passed to the second stage 635 where a spatio-temporal MV estimation process is used to identify candidate MVs. As with the first stage, MV errors are computed 640 for each candidate MV using SAD, or some other error estimation technique, as described above. Further, as described above, prior to evaluating particular MVs for a given block, a determination is made 645 as to whether that MV has already been evaluated, if so, then that MV value is simply read 650 from the aforementioned MV array 260 rather then reevaluating the error for that MV.

In either case, the MV for the current block that exhibits the lowest SAD value 655 is chosen to be the best candidate for the current block. The SAD for this MV is then compared to a threshold to determine whether it is reliable 660. If the SAD value of that MV is lower than a preset, user adjustable, or automatically determined error threshold, then it is deemed to be reliable 660 and is output 620 as the best estimate for the current block. On the other hand, if the SAD value of that MV exceeds the error threshold, then it is deemed to be unreliable 660 and that block is passed to the third stage 665 for evaluation.

As described above, the third stage uses one of the aforementioned block-based pattern searches for estimating MVs for each remaining block. Again, as described above, the third stage only operates on those blocks which were deemed unreliable in both the first stage 605 and the second stage 635. As with the second stage 635, the third stage again uses SAD, or some other error estimation technique, as described above, to estimate the error 670 for each candidate MV for a given block. The MV exhibiting the lowest SAD value 680 is output as the best MV for the current block. Further, as described above, prior to evaluating particular MVs for a given block, a determination is made 675 as to whether that MV has already been evaluated, if so, then that MV value is simply read 650 from the aforementioned MV array 260 rather then reevaluating the error for that MV.

The processes described above continue for each block in the current image frame until all blocks in the current image frame have been processed. At that point, the next image frame in the image sequence is provided to the predictive motion estimator to repeat the process again. This process continues until all image frames have been processed to estimate MVs, or until the process is terminated by a user or otherwise.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-readable medium having computer executable instructions for automatically estimating a motion field for image frames in an image sequence, said computer executable instructions comprising:
evaluating a first set of zero valued motion vector (MVs) for blocks in an image frame using background detection and determining a reliability of each MV;
evaluating a second set of one or more candidate MVs for each block in the image frame for which the first set of zero valued MVs was deemed not reliable, said second set of MVs being determined using any of spatial and temporal neighbors of each of those blocks, and determining an optimal MV for each block of the second set and a reliability of each optimal MV;
evaluating a third set of candidate MVs for all blocks in the image frame having MVs that were deemed not reliable using the first or the second set of MVs, said third set of MVs being determined using a block-based pattern search, and determining an optimal MV for each block of the third set; and
outputting an optimal MV for each block using the reliable MVs from the first, second and third sets of MVs to form a motion field for the image frame.

2. The computer-readable medium of claim 1 wherein reliability of the zero valued MVs is determined by computing error values for the MVs for each block in the image frame, and comparing the computed error values to a first error threshold.

3. The computer-readable medium of claim 2 wherein each block having a computed error value less than the first error threshold is deemed to have a reliable zero-valued MV.

4. The computer-readable medium of claim 1 wherein each optimal MV for the second set is determined by computing error values for each candidate MV of each block, and selecting a candidate MV having a smallest computed error value;

5. The computer-readable medium of claim 1 wherein the reliability of the optimal MVs for the second set is determined by comparing the error value of each optimal MV with a second error threshold, wherein any optimal MV having a computed error value less than the second error threshold is deemed to be a reliable MV.

6. The computer-readable medium of claim 1 wherein a second error threshold is computed as a minimum error value of the spatial and temporal neighbor blocks.

7. The computer-readable medium of claim 1 wherein the error value of the optimal MV for the second set is compared against a third threshold value, wherein:
if the error value is larger than the third threshold value, then the third set of MVs comprises the entire search range of the block-based pattern search; and
if the error value is smaller than the third threshold value, then the third set of MVs comprises a search range consisting of only immediate neighbor MVs of the optimal MV of the second set.

8. The computer-readable medium of claim 7 wherein the third threshold value is computed as a maximum of the computed error values of the spatial and temporal neighbor blocks.

9. The computer-readable medium of claim 1 wherein the pattern search is any of:
a square MV search;
a spiral MV search;
a 2 D logarithmic MV search.
a diamond MV search;
a hexagonal MV search; and
a two-level hexagonal MV search.

10. The computer-readable medium of claim 2 or claim 4 or claim 9 further comprising an array wherein computed error values for each MV are stored as they are computed.

11. The computer-readable medium of claim 10 wherein the array is checked before computing an error value for any candidate MV to determine whether an error value for that candidate MV has already been computed, and wherein if the error value for that candidate MV has already been computed, then it is read back from the array instead of being computed.

12. A system for estimating motion vectors (MVs) for blocks in an image frame, comprising:
inputting an image sequence comprising two or more images to a first MV estimation stage;
said first MV estimation stage using background detection to identify candidate MVs for background blocks in a current image frame from the image sequence;
determining whether each of the candidate MVs for the background blocks are reliable;
passing all blocks in the current image frame that are not background blocks, and all blocks in the current image frame that do not have reliable candidate MVs to a second MV estimation stage;
computing candidate MVs and an estimated error for all blocks in the second stage, and identifying the candidate MV having the lowest estimated error for each block in the second stage as a reliable MV for each particular block in the second stage; and
outputting the reliable MVs from the first stage and the reliable MVs from the second stage as the estimated MVs for the current image frame.

13. The system of claim 12 wherein the second MV estimation stage uses any of spatial and temporal neighbors of each block to compute the candidate MVs for each block in the second stage.

14. The system of claim 12 wherein a third MV estimation stage uses a block-based pattern search to compute the candidate MVs for each block in the third stage for blocks having MVs determined to be unreliable in the second stage.

15. The system of claim 12 wherein the second MV estimation stage uses a block-based pattern search to compute the candidate MVs for each block in the second stage.

16. The system of claim 14 or claim 15 wherein the block-based pattern search is any of:
a square MV search;
a spiral MV search;
a 2 D logarithmic MV search.
a diamond MV search;
a hexagonal MV search; and
a two-level hexagonal MV search.

17. A computer-implemented process for estimating motion vectors (MVs) for blocks comprising image frames in a sequence of image frames, comprising using a computer to:
input an image sequence comprising two or more images to a first MV estimation stage;
said first MV estimation stage using background detection to identify candidate MVs for background blocks in a current image frame from the image sequence;
determine whether each of the candidate MVs for the background blocks are reliable;
pass all blocks in the current image frame that are not background blocks, and all blocks in the current image frame do not have reliable candidate MVs to a second MV estimation stage;
said second MV estimation stage using any of spatial and temporal neighbors of each block to compute candidate MVs for each block in the second stage;
compute an estimated error for each candidate MV computed for the second stage and identifying the candidate MV having the lowest estimated error for each block in the second stage as a best candidate MV for each block;
determine whether each of the best candidate MVs for each of the blocks in the second stage are reliable;
pass all blocks in the current image frame from the second stage that do not have reliable candidate MVs to a third MV estimation stage;
said third MV estimation stage using a block-based pattern search to compute candidate MVs for each block in the third stage;
compute an estimated error for each candidate MV computed for the third stage and identifying the candidate MV having the lowest estimated error for each block in the third stage as a reliable MV for each block; and
output the reliable MVs from the first, second and third stages as the estimated MVs for the current image frame.

18. The computer-implemented process of claim 17 wherein the block-based pattern search is any of:
a square MV search;
a spiral MV search;
a 2 D logarithmic MV search.
a diamond MV search;
a hexagonal MV search; and
a two-level hexagonal MV search.

19. The computer-implemented process of claim 17 further comprising an array, equal in size to the number of MVs to be searched, wherein estimated errors for each MV are stored as they are computed.

20. The computer-implemented process of claim 19 wherein the array is checked before computing the estimated error for any candidate MV to determine whether an error value for that candidate MV has already been computed, and wherein if the estimated error for that candidate MV has already been computed, then it is read back from the array instead of being computed.

21. The computer-implemented process of claim 17 wherein the reliability the candidate MVs for the background blocks is determined by computing error values for the MVs for each block in the image frame, and comparing the computed error values to a first error threshold.

22. The computer-implemented process of claim 17 wherein the reliability of the MVs for the second stage is determined by comparing the error value of each best candidate MV with a second error threshold, wherein any best candidate MV having a computed error value less than the second error threshold is deemed to be a reliable MV.

23. The computer-implemented process of claim 22 wherein a second error threshold is computed as a minimum error value of the spatial and temporal neighbor blocks.

24. The computer-implemented process of claim 17 wherein the error value of the best candidate MV for the second stage is compared against a third threshold value, wherein:
if the error value is larger than the third threshold value, then the third stage of block-based pattern search comprises the entire search range; and
if the error value is smaller than the third threshold value, then the third stage of block-based pattern search comprises a search range consisting of only immediate neighbor MVs of the best candidate MV of the second stage.

25. The computer-implemented process of claim 24 wherein the third threshold value is computed as a maximum of the computed error values of the spatial and temporal neighbor blocks.
